(19) United States
(12) Patent Application Publication
(10) Pub. No.: US 2002/0001317 A1
(43) Pub. Date: Jan. 3, 2002

(54) System and method for voice and data over digital wireless cellular system

(75) Inventor: Russell M. Herring, San Antonio, TX (US)

Correspondence Address: Mark V. Muller, Esq., JENKENS & GILCHRIST, 3200 Fountain Place, 1445 Ross Avenue, Dallas, TX, 75202-2799, US

(73) Assignee: ATX Technologies, Inc.

(21) Appl. No.: 09/788,158

(22) Filed: Feb. 16, 2001

Related U.S. Application Data
(60) Provisional application No. 60/183,672, filed on Feb. 18, 2000.

(51) Int. Cl. H04Q 7/24; H04L 12/66; H04J 1/02; H04J 3/04

(52) U.S. Cl. 370/493; 370/338; 370/352; 370/535

(57) ABSTRACT

A method of combining voice and data for transmission in a single digital wireless telephone call comprises the steps of establishing a circuit-switched data call connection from a mobile phone to a destination, routing the call through a pair of modems connected in-line with the call connection path, multiplexing non-voice digital data with vocoded voice digital data to form a multiplexed digital data stream, and sending the multiplexed digital data stream from the mobile phone to the destination through the pair of modems.

A telephone for combining voice and data into a digitized data stream for delivery to a destination using a single digital wireless telephone call comprises a vocoder, a microphone, a speaker, a multiplexer having an encoded voice input and a data input, and a demultiplexer having a converted data input and a voice data output. The multiplexer is operatively connected to receive encoded voice output from the vocoder and the data. The demultiplexer is operatively connected to provide received voice data from a decoder in the vocoder and non-voice data.

A system for managing a combined data stream comprises a telephone for combining voice and data into the combined data stream which is transmitted from the telephone to the destination.

### REFERENCE TO RELATED APPLICATIONS

This application claims the benefit of priority from co-pending U.S. Provisional Application for Patent No. 60/183,672 titled “Voice and Data Over Digital Wireless Cellular System” filed on Feb. 18, 2000, is related thereto, is commonly assigned therewith, and the subject matter thereof is incorporated herein by reference in its entirety. This application also claims the benefit of priority from co-pending U. S. Provisional Application for Patent No. 60/206,135 titled “Voice and Data Over Digital Wireless Cellular System” filed on May 22, 2000, is related thereto, is commonly assigned therewith, and the subject matter thereof is incorporated herein by reference in its entirety.

### FIELD OF THE INVENTION

The present invention pertains to a voice and data communication system utilizing one implementation of a deployed digital wireless cellular system. The invention relates to a method of transmitting both voice and data in the same wireless connection, and describes a method of re-combining voice and data at a remote site if they become separated along the way.

### BACKGROUND

To fully understand the current implementation of the digital telephone system, a brief explanation of analog systems is necessary. The analog AMPS (Advanced Mobile Phone Service) system operates like a two-way radio system. Each direction of the wireless link behaves similarly to an FM (frequency modulated) radio broadcast. An analog voltage representing the sound signal is used to frequency modulate a carrier. The resulting modulated signal is then amplified and transmitted into the air. Reception of the signal involves a process which is similar to that which occurs within an FM radio receiver.

Each AMPS connection requires a pair of frequencies allocated within the broadcast band, one for transmission and one for reception. Each allocated frequency requires some bandspace around the frequency to pass the modulated signals and to prevent interference with adjacent frequencies. Therefore each connection requires a fixed bandwidth. The allocated frequencies and bandspace are called channels. Due to bandwidth limitations, there are a fixed number of channels in the AMPS system. As the number of users increase, the number of available channels is reduced, and service may not be available to someone trying to place a call.

In an effort to increase the availability of the telephony system to support additional connections, as well as for other reasons beyond the scope of this summary, the cellular telephone industry elected to create a new system using digital encoding techniques. Digital encoding entails converting an analog voice signal into a digital representation of its amplitude. This conversion process occurs many times per second in order to more accurately describe the input waveform. A binary representation of the original waveform results, which if transmitted directly, would require an enormous bandwidth compared to that required for conventional analog FM transmissions. However, the encoded voice can be compressed using an understanding of the characteristics of the human voice and a vocal tract mathematical model. The speech processed through such a vocal tract model may be viewed as a series of mathematical coefficients. It is this series of coefficients that is actually transmitted, presenting a much smaller data set than the original digital sample, obviating the need for large bandwidth. At the receiving end, the series of coefficients is used to excite a corresponding vocal tract model to reproduce the original sounds. This compression technique is called vocal tract encoding or Avocoding@. The engine used to effect vocoding is known as a vocoder.

FIG. 1 is a prior art illustration of a digital wireless cellular circuit-switched voice connection 200. Although a handheld wireless telephone 210 is shown, the actual mobile unit may take many forms such as a module embedded into another piece of equipment or a Ablack box@ with no user interface. Moving to the right in the figure, the cell antenna 220, Base Station Controller (BSC) 230, and Mobile Switching Center (MSC) 240 all belong to the WSP (Wireless Service Provider). The WSP has a connection to the PSTN (Public Switched Telephone Network) 250. Over the PSTN 250 the telephone company's Central Office (CO) 260 is connected to the telephone 270. This telephone 270 may be any type of telephony device that can interface to the PSTN 250 through analog or digital lines.

As shown, FIG. 1 illustrates a prior art handheld mobile telephone call-connected to a wired analog telephone 270. Although there are many alternate destinations for the call included in the system and method of the invention, an analog telephone 270 provides a simple illustration. To initiate the call, a request is made to the WSP for a circuit-switched voice call. This informs the WSP that a voice connection is desired and that the digital data received by the MSC 240 will be vocoded voice. The WSP places a call over the PSTN 250 to the destination 270. If the call is answered, then the connection is completed. The mobile telephone 210 takes the audio from its microphone and converts it into PCM (Pulse Coded Modulation) digital data. PCM is the digitization standard of the telephone industry, and is the most widely used. PCM is simply one form of representing an analog waveform digitally. The method of digitizing the analog voice waveform is not important as long as the same method is used at the transmission and the reception end. This digitized data then passes through the vocoder 345 and the mobile telephone 210 transmits the resulting vocoded data to a receiving antenna 220 that is part of the WSP=s network. The vocoded voice data travels through the BSC 230 to the MSC 240. The MSC 240 understands the data it is receiving to be vocoded voice and therefore passes this data through its own voice decoder that is part of its vocoding engine 355. The output of the vocoder 355 is PCM formatted voice. The PCM formatted voice data is now sent out over the PSTN 250. This PCM formatted voice is compatible with existing telephone switching systems and appears similar to PCM encoded voice from any other source, wired or wireless. When the PCM formatted voice reaches the land-based telephone company=s Central Office (CO) 260 that is connected to the destination telephone 270, the PCM formatted voice is converted back into an analog signal using a PCM decoder and sent to the telephone 270 over analog telephone lines 265. However, some land-based connections from the CO 260 to the phone 270 are completely digital and do not use analog telephone lines. In each case, if the voice is to be heard and understood by a person, the PCM data must eventually be converted back into an analog waveform to drive a speaker.

If the call connection is made in the reverse direction, such as when a mobile-terminated call is placed from the land-based analog telephone 270, the CO 260 connected to the originating telephone 270 routes the call request to the nearest WSP (i.e., the MSC 240) connection. The WSP keeps track of the last known location of the mobile telephone 210. The WSP routes the call request to the MSC 240 controlling the area in which the mobile telephone 210 was last reported. This MSC 240 then causes one or more BSCs 230 to transmit a page to that particular mobile telephone 210. If the mobile telephone 210 hears and responds positively to the page, then the connection is completed. Voice from the analog phone 270 is then sent to the CO 260 where it is PCM encoded (using a PCM encoder) and sent out over the PSTN 250 to the MSC 240 controlling the mobile telephone 210. The MSC 240 takes the PCM voice data, vocodes it, and transmits it to the mobile telephone 210. The mobile telephone 210 then passes the received vocoded voice through its voice decoder 345 resulting in PCM format digital data representing the analog voice signal. This PCM digital voice data is converted into an analog waveform, amplified, and presented to the speaker in the mobile telephone.

Human speech is slow and repetitive compared to fast data transmissions. The vocoder's sampling rate is intentionally set to a slow rate to limit the amount of data sent. This in turn reduces the bandwidth requirements when transmitting vocoded voice. Thus, the vocoding process works well for compressing human speech because it is optimized for speech.

As a matter of contrast, conventional methods of encoding data result in sounds that are not produced by the human vocal tract. The result is that attempting to send fast data through the vocoder is simply not feasible, because rapidly transmitted data encoded using these traditional means will not be accurately represented. Slow data can be passed through a vocoder, but this limits the applications for which such a system could be used.

For example, a technology exists whereby voice audio is digitized and combined with digital data and sent through the normal audio path to a destination. In this method, the goal is to produce a combined audio signal that can pass through the audio system of many telecommunications systems. As described earlier, in the digital cellular wireless telephone systems currently deployed the voice audio is passed through a vocoding system that is based on a vocal-tract model of the human voice. This system operates on human speech and the resultant data transmitted is a representation of that speech. This digital representation of human speech is then sent over the wireless link to be recreated into human speech at the receiving end. However, there are portions of the audio spectrum that carry less intelligible data than others. Digital data can be inserted into these portions of the audio spectrum normally occupied by voice. For example, the pauses between words and sentences can be used. This can be done in at least two ways.

Where the in-band system is separate from the digital telephone, a separate physical electronic circuit is created. This circuit takes as inputs the analog voice signal and the alternate digital data. The analog voice signal is digitized and some its bandwidth is removed. The digital data is converted into a signal similar to the types of sounds that normally pass through the vocoding system. The circuit inserts the digital data into the space removed from the voice data. The resultant combined digital representation is converted back into an analog signal and sent to the telephone as if it were coming from a microphone. The telephone believes that this signal is simply voice and vocodes it in the usual manner. The resultant vocoded signal is transmitted wirelessly to the receiving antenna. The vocoding system at the receiving antenna converts this digital representation of voice back into an analog signal to be sent on to the final destination where normally a speaker would reproduce the signal as voice. However in this in-band system, a special modem is used to separate the alternate digital data from the voice. The voice is sent to a speaker and the digital data is sent to its digital destination. In this manner voice and digital data are transmitted over the same digital call.

The second method of implementing this technique is functionally the same as the first, except there is no separate physical circuit needed. All of the functions are performed inside the phone itself. The processor in the phone actually executes an in-band algorithm to combine the voice audio and the digital data. This provides a lower cost implementation of the same system. Thus, the goal of the in-band system is to create a composite voice and alternate digital data signal that can pass through the vocoders of the digital cellular telephone system.

A problem with the in-band systems is that the data Asounds@ can usually be heard in the earpiece at the destination. While speech is not destroyed, it can be annoying. Also, by the very nature of the limitations of the vocoding systems, the data rate of any data sent through the vocoder is small when compared to other systems. Data rates up to about 600 bits per second are feasible. Some systems claim greater rates, but they are generally unreliable.

In an attempt to satisfy the needs of users who must send data through the digital system, a variation of the wireless connection has been implemented by the digital system providers. Whereas the voice connection is known as Acircuit switched voice,@ the data connection is known as Acircuit switched data.@ The term Acircuit switched@ refers to the fact that the connection passes through the telephone company standard switching system as opposed to a fixed, direct connection. The circuit switched data connection is data only, and the digital data using this path bypasses the vocoder to be transmitted as wireless digital data. There is no path provided for voice information in the circuit switched data connection.

Once wireless digital data has passed from a mobile unit, over the air interface, to the receiving system, it must somehow be routed to its intended destination. Since the data format used within the digital wireless system is not understood by most other equipment, the data is typically converted into a form understood by computer telephony systems worldwide: international standard modem format.

Millions of computers worldwide communicate with other computers or digital equipment over the PSTN utilizing modem technology. Modems condition data specifically so it can be routed through the PSTN. Therefore, WSPs typically take received wireless digital data from mobile units, convert the digital codes used over the wireless link into standard modem format, and send it on through the PSTN to the destination.

FIG. 2 is a prior art illustration of a digital wireless cellular circuit-switched data connection 300. In this case, the digital data 335 does not pass through the vocoder 345 at the wireless telephone 210 or at the MSC 240. Instead, the digital data 335 passes around the vocoders 345, 355. At the MSC 240, the digital data 335 passes to one of a bank of PSTN-type modems 330. The modem signal is then sent out over the PSTN 250 as a standard modem signal, where it is routed over the PSTN 250 to the destination and is terminated by another modem 340. The modem 340 can be connected to a variety of equipment, including a computer 350. Of course, the data 335 may originate from any digital radio 320, or from digital equipment 310 connected to the wireless telephone unit 210.

The circuit-switched data connection has several distinct differences from a circuit-switched voice call. In the mobile telephone 210, information is not routed through the vocoder 345. When the mobile telephone 210 requests a connection from the WSP, the mobile unit 210 must specify what type of connection is desired. This is called a Service Option (SO). When the circuit-switched data connection is requested, an SO specifying circuit-switched data is included in the call request. The WSP responds by placing a call through a PSTN modem 330 out over the PSTN 250 to the destination 340, 350. If answered, a modem answer tone followed by equalization and negotiation sequences peculiar to whatever modem standard is employed during communication with the originating modem 330 ensue. Once the modem connection is established, data can be exchanged in both directions. The digital data is routed around the vocoder in the mobile unit 210 and transmitted to the MSC 240. The MSC 240 bypasses the vocoder 355 and routes the data to the modem 330. The output of the modem 330 is converted to PCM format and sent out to the PSTN 250 and on to the destination 340, 350. At the destination 340, 350, the modem waveform is converted back into the original data to be used by whatever piece of digital equipment 350 is connected to the modem 340.

Existing landline telephone destinations have historically included a rack of telephone modems. These modems communicate using existing modem modulation standards such as CCITT V.32, V.34, V.90, etc. Since the purpose of the circuit-switched data scheme is to send data over the existing telephone system and since the classical system for receiving this data has been telephone modems, it was reasonable to simply take the wireless data, send it through a telephone line modem, and send this analog signal over the terrestrial telephone system. However, using an actual modem means the data that starts out as digital in the digital wireless cellular telephone is converted to analog by the modem at the MSC. Since much of the telephone system is actually digital today, this analog signal is immediately converted back to digital using a PCM encoder. PCM is the telephone company=s standard for digitized voice over the system. This digital data stream is combined with others and sent to the destination=s nearest central office. The PCM encoded modem signal is then converted back to analog and sent to the destination over normal Atip@ and Aring@ analog telephone lines. The method of presenting wireless digital data to a modem for modulation in preparation for sending it over a terrestrial telephone system is chosen for several reasons. First, because a modem is what will likely be on the other end of the line, and, second, this is the least expensive implementation because it has the least effect on other parts of the telephone system.

The PCM utilized by the telephone system is an 8-bit analog-to-digital (A/D) conversion process. The analog audio is first passed through a Acompressor@ stage whose purpose is to expand the signal=s dynamic range and thereby allow faint whispers and loud sounds to exist with normal speech volume. This is frequently a simple analog circuit but can be performed digitally also. This resultant compressed audio is presented to the input of a linear A/D. A digital representation of the magnitude of the signal is made 8,000 times per second. These samples are then sent serially over the digital telephone system. The signal normally is converted back to an analog signal to be sent out over the tip and ring analog telephone line. However, if the destination has a digital connection to the telephone central office, then the data is sent to the destination location while still PCM digital. If the actual modem at the MSC could be replaced with a modem emulator then the digital data could stay digital from one end to the other. This would result in less corruption of the data.

A summary of the entire process of a mobile-originated data connection is therefore:

a) The mobile unit 210 places a request for a circuit-switched data call 212.

b) The WSP receives the call request, and instead of routing the call directly through the PSTN 250, a telephone line modem 330 or modem emulator 332 is used to place the call through the PSTN 250.

c) The call is answered by a PSTN modem 340 at the destination. The modem 340 is usually connected to a computer 350, but not necessarily.

d) The modems 330, 340 negotiate the connection in the customary manner over the PSTN (as is well known in the art).

e) Once the negotiation process is ended, data can be exchanged between the mobile unit 210 and the destination equipment 350.

f) Digital data from the mobile unit 210 is routed around the vocoder 345, coded according to the appropriate manner for the wireless link, and then transmitted (as is well known in the art).

g) The signal is then received by the WSP and routed to the modem 330 at the MSC 240.

h) The MSC modem 330 processes the data in the standard manner to be compatible with the PSTN 250.

i) The modem-encoded data passes through the PSTN 250 to the destination modem 340.

j) The destination modem 340 decodes the received data into the original data format and presents it to the host equipment 350.

This prior art method concentrates on the origination of the call by the mobile unit 210. A variation of this prior art method can also be used for a mobile terminated call. When a mobile-originated call is placed, the mobile unit 210 identifies the type of call as a “circuit-switched data call”. This informs the WSP that the information to be passed through the modem is data, and not vocoded voice. The call is placed from the WSP=s location over the PSTN 250 using the modem 340 as described above. However, if the call originates from the destination 340, 350 to the mobile unit 210 using a modem (or modem emulation) described above, the destination 340, 350 places the call using its modem 340 to the mobile unit 210. The PSTN 250 recognizes the telephone number provided by destination 340, 350 as a wireless phone and routes it to the appropriate WSP. The WSP in turn pages the mobile phone 210 in the area where the phone is known to be located. Up to this time the terrestrial phone service provider and the WSP do not know that a digital data call is being attempted. This is because there is no easy way to communicate this information to the terrestrial system service provider and then on to the WSP using an analog telephone line. Therefore, each entity believes the call to be a normal voice connection. Thus, if the call is to be a circuit-switched data call, the mobile unit 210 must respond to the WSP=s page in a special manner, indicating that it will accept the call only as a circuit-switched data call. It does this by specifying circuit-switched data as the SO. The WSP then re-routes the call around the vocoder 355 and through a modem 330 connection. The incoming call from the destination 340, 350 must also be routed to the same modem 330. The modem 330 at the WSP then begins the selected modem answer tone, equalization, and negotiation sequences peculiar to whatever modem standard is employed for communicating with the originating modem at 340. Once the two modems 330, 340 are ready, data can be transferred in both directions. Note that the mobile unit 210 must recognize that the incoming call is to be circuit-switched data at the moment it answers the call. This is a limitation for telephones typically used for voice communication. The WSPs assume that almost all circuit-switched data calls will be mobile-originated within the currently-deployed system. As will be explained later, this may limit the expected call type when a mobile unit does not originate the call (within conventional systems).

As the WSPs expand their infrastructure capabilities, a more integrated implementation of simultaneous voice and data communication can be realized. In fact, a number of methods for transmitting simultaneous voice and data over these systems already exist. In a TDMA system, for example, the mobile unit sends digitized voice in one assigned time slot and then sends digital data in another assigned time slot. Another example includes the CDMA system, wherein two digital data streams are given different codes and transmitted truly simultaneously. The WSP may in this case treat the voice and data as two separate communication sessions, directing each to a different destination. In fact, many data or voice sessions can be occurring simultaneously. Thus, a method is needed to combine these simultaneous voice and digital data communication sessions at some remote site.

In summary, currently deployed digital wireless cellular systems allow circuit-switched voice connections and circuit-switched data connections. An Internet packet connection is also implemented. Although the applicable approved standards describe many different types of connections, only a few are currently implemented by the digital cellular wireless system providers (WSP). While the analog AMPS (advanced mobile phone service) cellular system is capable of transmitting both voice and data in the same call, and various systems are on the market that implement this function, digital services employ vocal tract modeling and compression techniques that prohibit several popular methods of transmitting data. Since many applications require handling both voice and data in the same call, there exists a need in the art for voice and data transmission within a single digital wireless call over the currently deployed systems. In addition, when the WSPs expand their infrastructure capabilities to include a voice call in progress simultaneously with a data transmission, a method is needed to combine these two calls into one at the remote location.

### SUMMARY OF THE INVENTION

The invention includes a method of combining voice and data for transmission during a single digital wireless telephone call. The steps of the method include establishing a circuit-switched data call connection from a mobile phone to a destination, routing the call through a pair of modems connected in-line with the call connection path, multiplexing non-voice digital data with vocoded voice digital data to form a multiplexed digital data stream, and sending the multiplexed digital data stream from the mobile phone to the destination through the pair of modems.

In another embodiment, the invention includes a method of establishing a plurality of simultaneous connections between a digital cellular radio and a wireless system provider, comprising the steps of establishing a voice connection between the digital cellular radio and a wireless system provider and establishing a digital data connection between the digital cellular radio and a wireless system provider wherein the voice connection and the digital data connection are active at the same time and treated independently by the wireless system providers. The voice connection and the digital data connection can be made to the same destination, which may be an operator workstation. The digital data connection carries information about the voice connection.

Another aspect of the invention includes a telephone for combining voice and data into a transmitted digitized data stream to be transmitted by way of a single digital wireless telephone call and for receiving a received digitized data stream including received voice data and received non-voice data. The telephone has a voice input, a sound output, a data input, a non-voice data output, and an antenna. The telephone also includes a vocoder having an encoder including a digitized voice input and an encoded voice data output, and a decoder including a received voice data input and decoded voice data output, a microphone operatively connected to an analog-to-digital converter which provides a digitized voice data stream to the digitized voice input in response to the voice input, a speaker operatively connected to a digital-to-analog converter which receives a digital data stream from the vocoder decoded voice output to provide the sound output, a multiplexer having a multiplexed data output, an encoded voice input, and a data input, the multiplexer operatively connected to receive the encoded voice output at the encoded voice input and the data at the data input so as to provide a transmitted digitized data stream, and a demultiplexer having a converted data input, a voice data output, and a non-voice data output, the converted data input operatively connected to receive the received digitized data stream, the voice data output operatively connected to provide received voice data to the decoder received voice data input, and the non-voice data output operating to provide the received non-voice data to the non-voice data output.

The invention may also a system having a telephone, as described in this section, in electronic communication with a destination, operating according to the method of the invention. In another embodiment, the invention includes a system for managing a combined data stream, comprising a telephone for combining voice and data into a transmitted digitized data stream to be transmitted by way of a single digital wireless telephone call and for receiving a received digitized data stream including received voice data and received non-voice data, the telephone having a voice or sound input, a sound output, a data input, a non-voice data output, and an antenna. The telephone in the system may include a vocoder having an encoder including a digitized voice input and an encoded voice data output, and a decoder including a received voice data input and decoded voice data output, a microphone operatively connected to an analog-to-digital converter which provides a digitized voice data stream to the digitized voice input in response to the voice or sound input, a speaker operatively connected to a digital-to-analog converter which receives a digital data stream from the vocoder decoded voice output to provide the sound output, a multiplexer having a multiplexed data output, an encoded voice input, and a data input, the multiplexer operatively connected to receive the encoded voice output at the encoded voice input and the data at the data input so as to provide a transmitted digitized data stream, and a demultiplexer having a converted data input, a voice data output, and a non-voice data output, the converted data input operatively connected to receive the received digitized data stream, the voice data output operatively connected to provide received voice data to the decoder received voice data input, and the non-voice data output operating to provide the received non-voice data to the non-voice data output, and a mobile switching center including a first modem, the mobile switching center operatively coupled to the telephone so as to receive a representation of the amplified output data stream from the telephone and to send the representation of the amplified output data stream to the first modem, and to receive a representation of the received digital data stream from the first modem and to send the representation of the received digital data stream to the telephone, a central office connected to the first modem; and a destination including a second modem connected to the central office.

### BRIEF DESCRIPTION OF THE DRAWINGS

A more complete understanding of the structure and operation of the present invention may be had by reference to the following detailed description when taken in conjunction with the accompanying drawings, wherein:

FIG. 1, previously described, is a prior art block diagram of a circuit switched telephone voice connection;

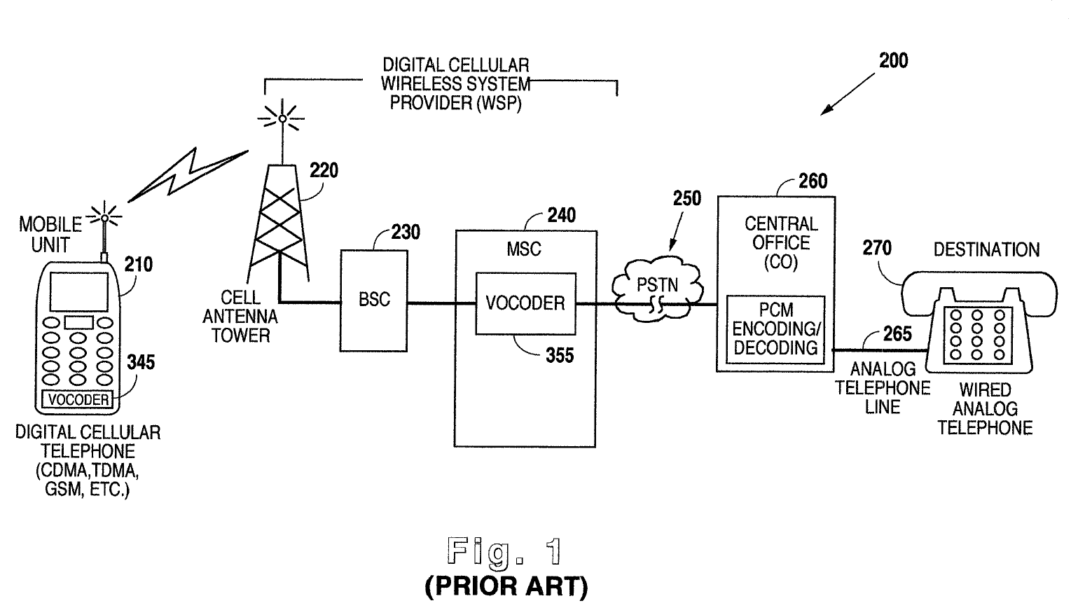

FIG. 2, previously described, is a prior art block diagram of a circuit switched telephone data connection;

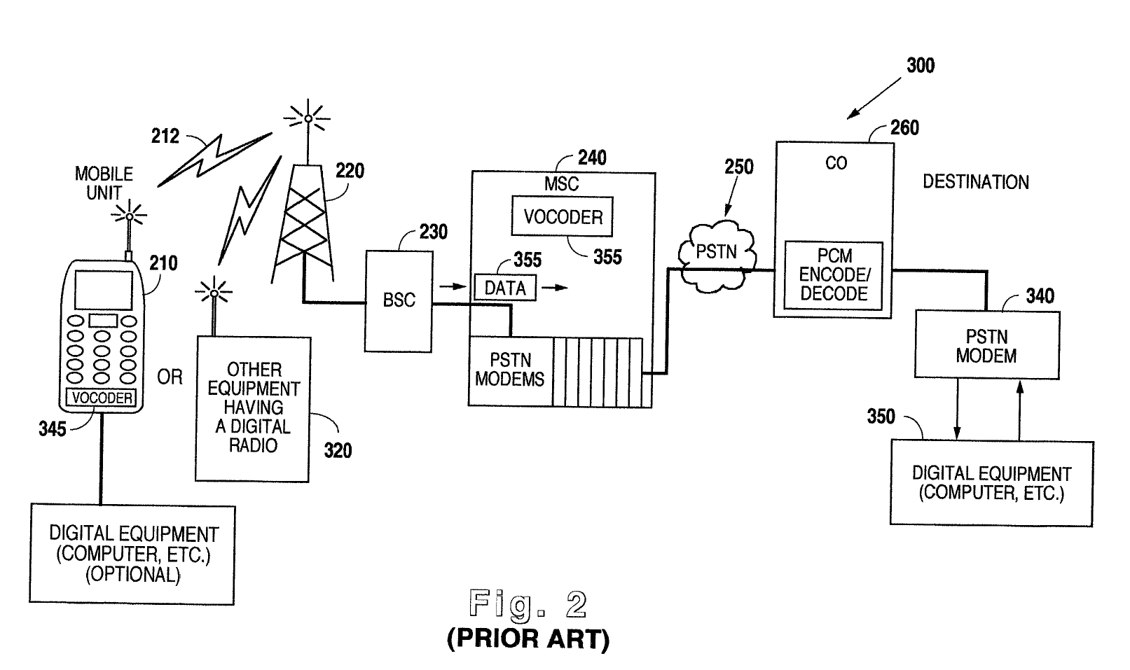

FIG. 3 is a block diagram of the telephone of the present invention, configured in an exemplary fashion for CDMA operation;

FIG. 4 is a block diagram of the telephone of the present invention, configured in an exemplary fashion for TDMA operation;

FIG. 5 is a block diagram of the network of the present invention, illustrating simultaneous voice and data communication with a single PSTN call connection;

FIG. 6 is a block diagram of the network of the present invention, illustrating simultaneous voice and data communication with a single alternate network call connection;

FIG. 7 is a block diagram of the network of the present invention, illustrating simultaneous voice and data communication with a dual-call PSTN connection;

FIG. 8 is a block diagram of the dual-call telephone of the present invention, configured in an exemplary fashion for dual-call CDMA operation;

FIG. 9 is a block diagram of the dual-call telephone of the present invention, configured in an exemplary fashion for dual-call TDMA operation; and

FIG. 10 is a block diagram of the method of the present invention.

### DESCRIPTION OF THE PREFERRED EMBODIMENTS

The invention described herein utilizes a novel variation of the circuit-switched data method to send both voice and data in the same connection. In short, the voice signal is vocoded (as would occur for a circuit switched voice connection), combined with a separate stream of alternate digital data (any other non-voice data), and the combined digital data stream is sent out of the mobile unit as a single stream of wireless digital data to the WSP. The method described herein is specifically designed to be used with the digital cellular wireless telephone system currently implemented by the digital WSPs.

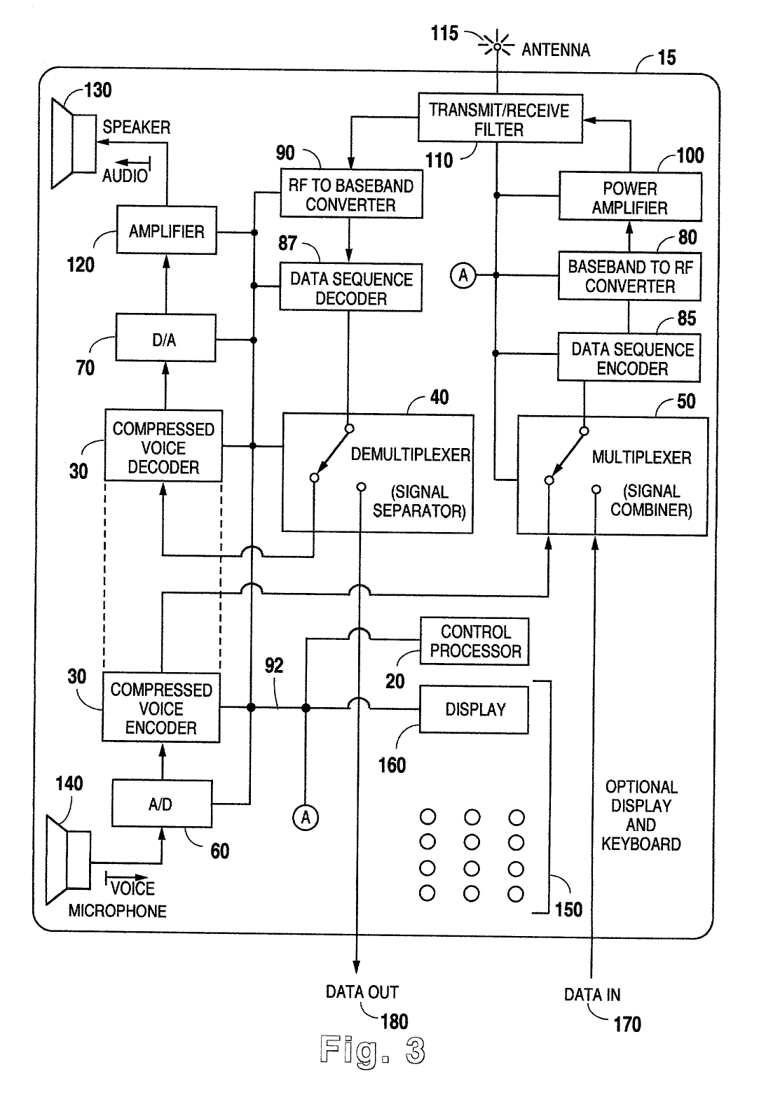

FIG. 3 is a simplified drawing of an exemplary single-call digital cellular 2-way radio 15 configured for CDMA operation, and capable of implementing the method of the present invention. The 2-way radio 15 can be built as a hand-held, battery-powered, wireless telephone, a mobile wireless radio embedded in a vehicle, a stationary radio attached to another piece of equipment, or any of many other possibilities. The radio 15 can be a hand-held device with a digital port to some other piece of equipment, or be totally embedded within a machine to provide a wireless voice/data connection. If hand-held, the source and destination of the data can be inside the telephone 15 itself with no need for any additional equipment to generate or make use of the data. Whatever the application, the radio 15 operates compatibly with the currently deployed digital cellular system.

The radio 15 is comprised of several major blocks: The control processor 20, the vocoder (for voice encoding and voice decoding) 30, data source multiplexer 40 and demultiplexer 50, an analog-to-digital converter 60 and a digital-to-analog converter 70, a baseband-to-RF converter 80 and an RF-to-baseband converter 90, a power amplifier 100 for the RF signal, a duplexer 110 to separate the transmitted signal from the received signal at the antenna 115, an audio power amplifier 120 for a speaker 130, a microphone 140 and associated circuitry, and a keyboard 150 and display 160.

Operation as a voice telephone requires that all of the voice data pass through the vocoder 30 in both directions. If the radio 15 is used to send/receive digital data, then the multiplexer/demultiplexer (MUX/DEMUX) 40, 50 is used to route the data 170, 180 to and from the RF circuitry 80, 90, 100, 110 without involving the vocoder 30. If the radio is to be used in the voice and data mode then the MUX/DEMUX 40, 50 is used to rapidly switch between vocoded voice data and the digital data. The control processor 20 controls all activity inside the radio 15. The circuit elements may be implemented as depicted in the drawing or possibly as elements whose inputs and outputs are available to a bus structure (not shown) that allows the control processor 20 to directly control each function of the radio 15.

Some WSPs do not use the term Acellular@ when describing digital wireless systems such as the TDMA (Time Division Multiple Access), CDMA (Code Division Multiple Access), and GSM (Global System Mobile) systems. These WSPs use the term Acellular@ to describe only analog systems, such as the AMPS. However, all of these wireless systems rely on the antenna transmission network being cellular in nature. Thus, the term Acellular@ actually refers to the grid of antennas deployed and the fact that the mobile unit is switched from antenna to antenna, sharing radio frequencies according to some agreed upon plan as the mobile unit moves throughout the service area. A hexagonal pattern is frequently deployed that looks similar to a bee=s cellular honeycomb. Each hexagonal area is called a cell.

The CDMA phone 15 includes functional blocks arranged to show signal flow and do not necessarily represent actual hardware. The architecture of a typical phone is usually implemented with a bus-type configuration, such as using a bus 92. The control processor 20 moves data from one block to another across this internal bus 92. The CDMA code sequencers 85, 87 are typically implemented in a dedicated digital signal processor (DSP). One of the methods of the present invention begins when a single circuit-switched call is placed.

Once the data path is established, the phone 15 begins to transmit the data. The control processor 20 takes digitized and vocoded voice data and the alternate digital data and multiplexes both into a single packet referred to as a frame. This composite frame is divided into a voice section and an alternate digital data section. Whether it is of fixed format or variable format is typically described in the header of the frame. When voice is not present more of the frame can be used for alternate digital data. This is the reason for a variable format. Once the frame has been constructed, some circuit-switched-data framing is added for use by the phone 15 and the cell tower to control the call and the transmission of data. The data is then sent to the data sequence encoder 85. This function uses a unique code sequence to spread the frame data transmission across the spectrum of the channel assigned to the call. This spread spectrum characteristic is fundamental to the operation of the CDMA system. Since one call is in progress, one sequence is used for the circuit switched data transmission. The spread-spectrum baseband signal is then used to modulate the transmit carrier. The radio frequency signal is then amplified and passed through a transmit/receive filter 110 designed to prevent the phone's transmission from over-driving its own receiver. The signal then exits the radio 15 through the antenna 115.

The received signal passes through the transmit/receive filter 110 and is down-converted to its original baseband frequency via the RF to baseband converter 90. The signal then passes through the data sequence decoder 87. This section uses the same sequence used for its transmission from the cell tower to separate the proper signal from the multitude of other signals received. The transmission framing used by the phone 15 and cell tower are then removed and the result is the transmitted composite frame. The demultiplexer 40 then separates the voice data from the alternate digital data. The alternate digital data is sent out its port 180 and the voice data is sent to the compressed voice decoder 30. The original vocal tract model vocoder is used here to generate voice from the vocoded data. The decoded voice data is then sent through a digital-to-analog converter 70 to produce an analog signal which is then amplified using the amplifer 120 and sent to the speaker 130 as audio.

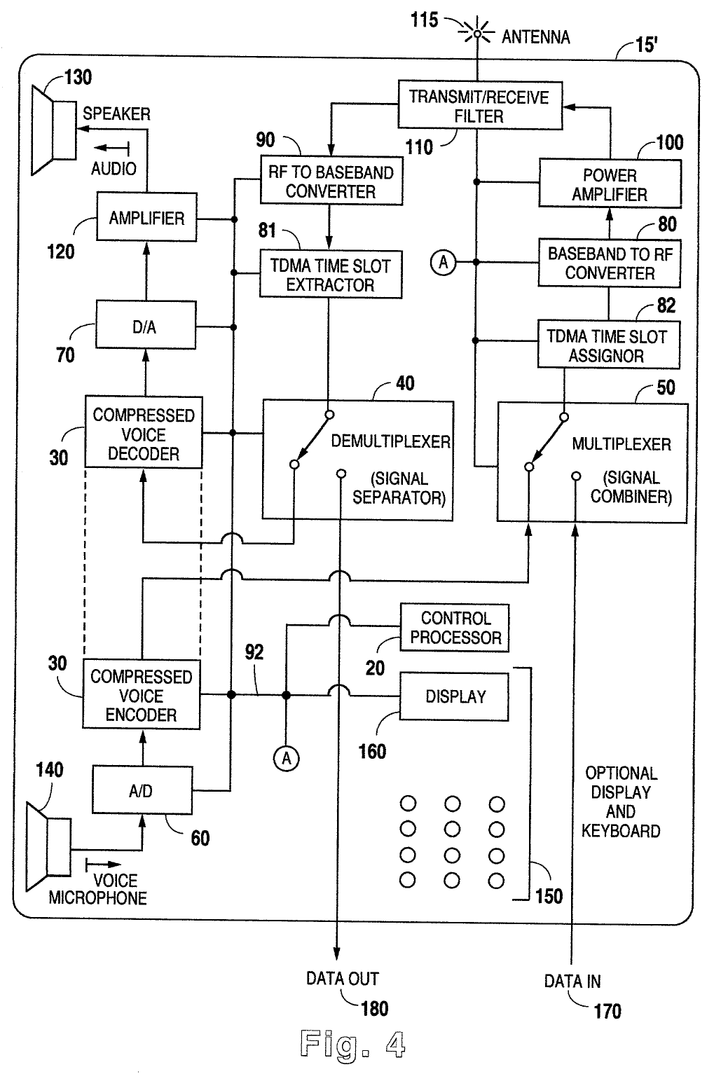

FIG. 4 illustrates an exemplary single-call digital cellular 2-way radio 15′ configured for TDMA operation, also capable of implementing the method of the present invention. The TDMA phone 15′ is also shown as a simplified functional block diagram, and does not necessarily show all of the physical components of the phone 15′, but is used to explain the operation of the phone 15′ using one of the methods described herein. Thus, the blocks are arranged to show signal flow and do not represent actual hardware. The control processor 20 typically moves data from one block to another across the internal bus 92. To begin the method of the invention, a single circuit-switched data call is placed.

Once the data path is established, the phone begins to transmit the data. The control processor 20 takes the digitized and vocoded voice data and the alternate digital data and multiplexes both into a single packet referred to as a frame, using the multiplexer 50. This composite frame is divided into a voice section and an alternate digital data section. Whether it is of fixed format or variable format may be described in the header of the frame. When voice is not present more of the frame can be used for alternate digital data, using a variable format. Once the frame has been constructed, some circuit-switched-data framing is added for use by the phone 15′ and the cell tower to control the call and the transmission of data. The data is then sent to the data time slot assigner 82. The purpose of the time slot assigner 82 is to insert the digital data frame into a time slot used by the TDMA wireless cellular system. Each radio 15′ is assigned a different time slot at a particular radio frequency. Each radio 15′ only transmits and receives during its assigned time slot. When this radio's time slot arrives data is transmitted until its time slot is over. It is not necessary to transmit the entire composite frame during one time slot. The transmitted data will be concatenated at the BSC or MSC. During this radio's assigned time slot the radio frequency carrier is turned on, amplified by the amplifer 100, and passed through a transmit/receive filter 110 designed to prevent the phone's transmission from over-driving its own receiver. The signal then exits the radio through the antenna 115. When the time slot is over, the carrier is turned off.

The received signal passes through the transmit/receive filter 110 and is down-converted to its original baseband frequency. The signal then passes through the time slot extractor 81. The purpose of the extractor 81 is to retrieve the data out of this radio's assigned time slot. The transmission framing used by the phone and cell tower are then removed and the result is the transmitted composite frame. The demultiplexer 40 then separates the voice data from the alternate digital data. The alternate digital data is sent out the data output port 180 and the voice data is sent to the compressed voice decoder 30. The original vocal tract model vocoder is used here to generate voice from the vocoded data. The decoded voice data is then sent through a digital-to-analog converter 70 to produce an analog signal, which is then amplified using the amplifier 120 and sent to the speaker 130 as audio.

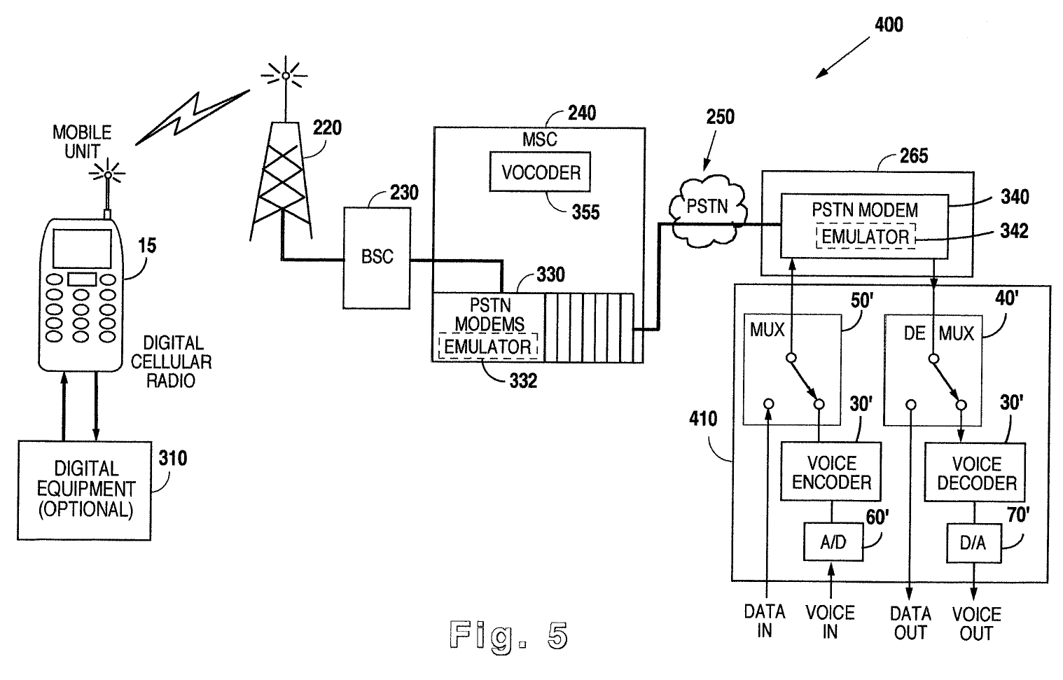

FIG. 5 illustrates a simultaneous circuit-switched voice and data connection using the method and apparatus of the present invention. Elements having similar numeric designations, such as the vocoder 30 and vocoder 30′, are intended to be functionally similar, or identical, and may also be physically similar or identical. The most important concept involved in this apparatus and method is that much of the technology currently implemented by the wireless industry can be used. Typically, no additional hardware is required for implementation (using software program modules) within a standard mobile unit.

The method makes use of a standard circuit-switched data call. Once the call request has been transmitted to the WSP, a modem call is placed to the destination as described above. Once the modems at each end of the call have negotiated the connection, data exchange can begin. It is important to note that data transmission occurs simultaneously in both directions—from the mobile unit 15 to the destination 410 and from the destination 410 to the mobile unit 15. The destination 410 can also be similar to, or identical to, the mobile unit 15. Vocoded voice data is assembled into a stream of data at either a fixed or variable rate depending upon the type of vocoder 30, 30′ utilized. Frames (or packets) of vocoded voice data are compiled and transmitted. The transmission rate of the vocoded voice data stream must be less than the maximum circuit-switched channel data rate. This allows bandspace for the vocoded voice, the wireless data channel overhead, and also provides bandspace to transmit additional data from another source, if desired.

Thus, the method described uses many various prior art components of both the circuit-switched data connection and the circuit-switched voice connection described herein. The path of the voice information is through vocoders at both ends of the connection; i.e., in the phone 15 and the equipment or phone 410, but not the vocoder 355 at the MSC 240. The telephone 15, or any other compliant digital cellular wireless radio, multiplexes the vocoded voice packets and the digital data packets and sends them to the MSC 240 using a circuit-switched data call. The MSC 240 passes this digital data through the modem 330 to the end point destination 410, where a similar modem 340 separates the alternate digital and the vocoded voice packets. The vocoded voice information is further routed through the voice decoder 30′ to result in Pulse-Code-Modulated (PCM) encoded voice. This digital voice is converted back to an analog signal and presented to the operator or other destination.

The vocoded voice and the additional digital data can be included in the same or in separate frames. By encoding the data stream to include a voice frame and a separate data frame, each can be treated differently. Voice information is time sensitive. If the voice information is corrupted anywhere during its travel time from the mobile unit 15 to the destination 410, it may be unreasonable to retransmit it. Unless the wireless transmission rate is significantly greater than the voice information transmission rate, there will not be enough time to retransmit an uncorrupted version of the voice information. If the voice information frames are short, retransmission might be possible, but shorter frames require more overhead. This results in less data bandspace availability. If the connection is poor and many errors occur, at some point the data cannot be retransmitted with (approximately) real-time reception of sound. Long time delays result, and the speech quality is impaired. Therefore, some corrupted voice data packets would simply have to be ignored by the destination 410 and appear as dropouts, moments of silence, or extrapolations of previous correctly received sounds. Many possible methods (well known in the art) might be employed to recover damaged voice frames. However, it is important to note that some voice frames will become corrupted, and may thus be eliminated from reproduction at the destination 410. This means that some method of detecting and/or correcting errors in each frame will likely be needed. However, it is a characteristic of many voice applications that small quantities of sound can be eliminated (e.g. minor dropouts) without compromising the intelligibility of the speech.

Conversely, for many types of digital data (non-voice) it is necessary to make certain that the data gets through uncorrupted. This data can normally be retransmitted as desired until it is accurately received because uncorrupted reception of data may not be as time critical as voice reception. Retransmissions, which cause the data to arrive in packets that are out of sequence, typically have no ill effects. Such packets can easily be arranged in the proper order. Therefore, a totally different technique for error control can be used on the digital data as compared to the vocoded voice information. Again, many techniques well known in the art can be employed to accomplish this objective.

Thus, one implementation of this system makes use of an error protected vocoded voice frame and an error protected alternate digital data frame. These frames may be separate and distinct in their format, error detection scheme, and retransmission methodology. The voice frame typically will have priority for transmission, and whatever bandspace is available after the voice is sent can be used for retransmission of corrupted voice frames and/or for transmission of alternate digital data. The selective transmission of one type of frame followed by another type of frame is known as multiplexing.

Some vocoding schemes are variable in rate, meaning that they do not use a fixed amount of bandspace. The original intention of this variable rate characteristic was to provide a decreased bandspace requirement for the vocoded voice during pauses in speech, or between words. However, in a circuit-switched data connection the wireless data transmission occurs at a constant bit rate. This means that a variable rate vocoder allows more bandspace for alternate digital data frames when speech is paused or stopped. It must be remembered that this is a two-way connection, since voice and data go both directions. Voice conversations are typically half-duplex, meaning that both people are not usually speaking at the same time. This allows even greater utilization of the bandspace for alternate digital (non-voice) data.

The method and apparatus has been described as using a modem as part of its operation. However, an actual, physical modem is not required. The terrestrial PSTN carries mostly digital-data today. Voice is converted to digital data (but is not vocoded) and is multiplexed with other connections into a high speed serial stream sent out over a variety of physical links such as fiber, radio, twisted pair copper wire, and coaxial cable. Modem data is able to pass through the PSTN system because digital voice data is not compressed using a vocal tract model.

Instead of routing the wireless digital data from the mobile unit to an actual modem, a modem emulator can be used. Thus, instead of using modems 330, 340, emulators 332, 342 respectively, might be used to replace either or both of them. These emulators 332, 342 operate by taking the digital data recovered from the circuit-switched data connection to the mobile telephone and converts it into a PCM representation of the analog voltage waveform that an actual modem would have produced. The analog voltage waveform produced by a standard modem is well known for a given set of data, or receiving modems could not demodulate the data. It is also well known what the digital PCM values will be for a given analog voltage. By knowing what the modem output voltage will be for a given set of digital data input, and by knowing what PCM digital value represents that voltage, a digital conversion can be made directly from the digital data received from the wireless connection at the MSC to the proper PCM equivalent. In actuality, the modem emulator may be realized as a software algorithm executing in the computer at the MSC (or in the BSC, or anywhere else a conventional modem is typically located). Firmware or a Digital Signal Processor (DSP) can also be used. In this way the data is never converted into an analog waveform.

Every time a conversion from digital to analog is performed, and vice-versa, the signal-to-noise ratio decreases. However, when the physical modem at the MSC is replaced with a modem emulator, the data is maintained in digital form. The emulators 332, 342 operate as code converters that never actually change wireless data from the mobile unit 15 or the destination 410 into an analog waveform. Thus, the emulators 332, 342 can directly convert the digital data from the mobile unit into the PCM digital equivalent of the waveform that would have been created using a standard modem. When the CO 265 receives emulator-encoded PCM data, it is indistinguishable from an analog modem output. This method of operation provides a better error rate than standard hardware signal conversion.

Thus, the emulator might operate by taking in received data from the mobile unit 15 and converting it into the PCM codes necessary so that a physical modem at the destination (e.g., modem 340) is able to decode the original data. For example, if the V.34 modem standard is used, mobile unit data would be converted into a digital representation (in PCM) of the V.34 waveform describing the input data. This PCM sequence would be sent over the PSTN 250 to the destination 340, 410. If the destination includes an analog telephone line, then the telephone company CO converts the PCM data back into an analog signal and sends it to the destination as an analog voltage. A real V.34 modem at the destination would then demodulate the analog signal back into the original data. If the connection to the ultimate destination is digital (instead of analog) then the PCM data can be sent all the way to the destination without ever being converted into an analog signal. This has the advantage of fewer errors in the data because an analog connection typically has a higher bit error rate than a digital connection.

As mentioned above, a limitation of the prior art circuit-switched data scheme is that with a normal voice-type phone that is also data capable, the type of call must be identified by the mobile unit before the call is actually answered. However, the mobile unit may not know what type of call is coming in and the call type may not be able to be changed once the call is in progress. Using the system and method of the present invention, all mobile-terminated calls become circuit-switched data calls. The vocoded voice becomes a part of the data. The system providers do not know (and do not need to know) that voice is included in the data. Therefore, the described limitation for the prior art scheme is removed by the invention. In both types of calls, the destination 410 can be a fixed location or a mobile unit.

Thus, the above-described voice and data transmission/reception apparatus 15, 410 and method of transmitting and receiving voice and data information over digital wireless phone connection makes use of many elements currently deployed in the digital wireless system. The system and method have the advantage of using the vocoder that already exists in voice type wireless phones. Mobile unit hardware can be developed more quickly, with lower cost, smaller size and power, and greater acceptance by the phone manufacturers, since all critical hardware parts of the new wireless mobile unit 15 are implemented in currently-available phones. Also, by tailoring the framing and multiplexing scheme specifically to the separate and distinct requirements of voice and data frames (or packets), the apparatus and method can provide an optimum connection for both voice and data, simultaneously.

Currently, the digital wireless system that supports modem connections to a mobile unit is the CDMA system described in the IS-95 standard and its amendments. This system is implemented within the 1900 MHz frequency band, as well as within the 800 MHz frequency band. However, the concepts described above are not contingent on the wireless frequency of the system, but rather, they describe operations at the baseband level. Also, the invention is not limited to the CDMA system. If the modem connections are in place, it can operate on any digital wireless system.

Since the WSP does not realize that a voice and data call utilizing this method is any different from a simple circuit-switched data call, the call connection can be established in a manner identical to the conventional circuit-switched data call. However, the actual data sent over the system is, in fact, encoded voice and data, multiplexed together. When paged by the BSC 230 mobile unit 15 always responds with an SO selecting circuit-switched data. This eliminates the problem of answering a data call in voice mode. The transmission of data continues as described above for a mobile-originated call.

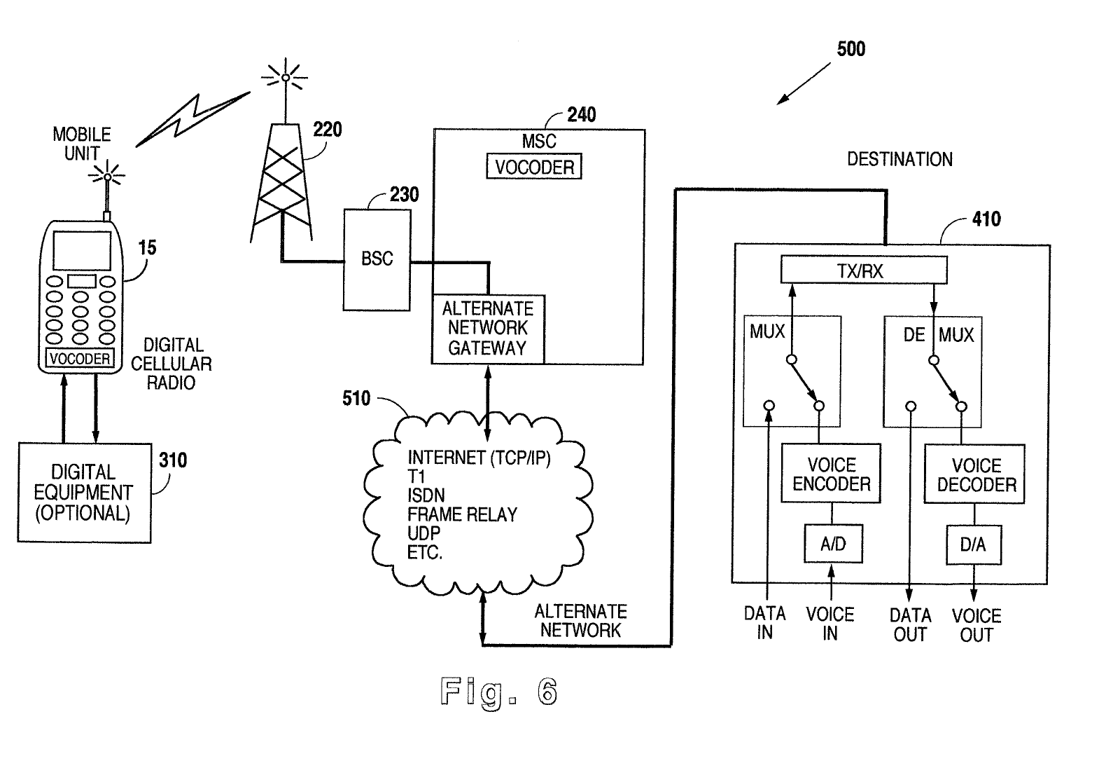

FIG. 6 illustrates a voice and data connection 500 over an alternate network 510. Neither the PSTN or a modem is used by this type of connection. Instead, the connection is made through some alternative type of network, such as an Integrated Services Digital Network (ISDN), T1 and its derivatives, the Internet, or any other digital link. Protocols such as Transmission Control Protocol/Internet Protocol (TCP/IP), Asynchronous Transfer Mode (ATM), User Datagram Protocol (UDP), Frame Relay, and others, can be used. The transmission medium and the protocol are not critical to the implementation of this invention. The only requirement is that the connection provide bi-directional (full duplex) communication. When a connection is desired by mobile unit 15, a request is made to the WSP similar to the circuit-switched data call, but using a destination designation reference number different from a standard telephone number (e.g., an Internet node address, or some other network address). This request is interrogated by the WSP and determined to be an alternate network request. The MSC 240 (or other control point or node in the WSP=s system) establishes a connection with the destination 410 over the alternate network 510. Now the mobile unit 15 can send packets of data (using the deployed network transmission medium and protocol) to the destination 410. Data can likewise be sent from the destination 410 to the mobile unit 15.

In one embodiment of the method, the transmission medium is the Internet 510 and the protocol is TCP-IP. The alternate network destination address is the Internet address of the destination 410. Packets of data would be sent from the mobile unit 15 over the wireless link to the BSC 230 and on to the MSC 240. The MSC 240 can then construct a TCP-IP data packet with the data from the mobile unit 15 and route it onto the Internet 510. The TCP-IP packet then travels over the Internet 510 to the destination 410. TCP-IP guarantees delivery, so packets received correctly are acknowledged.

A variation of this method is the use of a protocol that does not include guaranteed packet delivery. The problem with guaranteed delivery is that if the data is corrupted during transmission, the data must be retransmitted. As described above, this is not always desirable. However, guaranteed delivery of alternate digital data may be desired. Therefore, a better protocol would be one that does not automatically retransmit messages that do not get through. The next higher level in the application software might be programmed to selectively provide retransmissions for digital data, but not voice data. One such protocol to accomplish selective retransmission is UDP. This protocol does not require that the data get through uncorrupted, yet operates over the Internet 510.

In order for the destination 410 is to establish a connection with the mobile unit 15, there must be an address defined for the mobile unit 15 that is visible from the alternate network. For example, the connection may be established by sending a packet of data from the destination 410 with the mobile unit 15 address to the WSP. The WSP maintains a database of the last reported location of the mobile unit 15. This database identifies the MSC 240 last serving the mobile unit 15. The packet is routed to the MSC 240 last serving the mobile unit 15 and a page is transmitted to the mobile unit 15 by one or more BSCs 230. The mobile unit 15 then responds to the page with a digital data SO that informs the WSP that the mobile unit 15 can establish a digital data connection. Once the connection is established, digital data packets containing voice data and digital data can be transmitted in both directions as described previously for a mobile-originated connection.

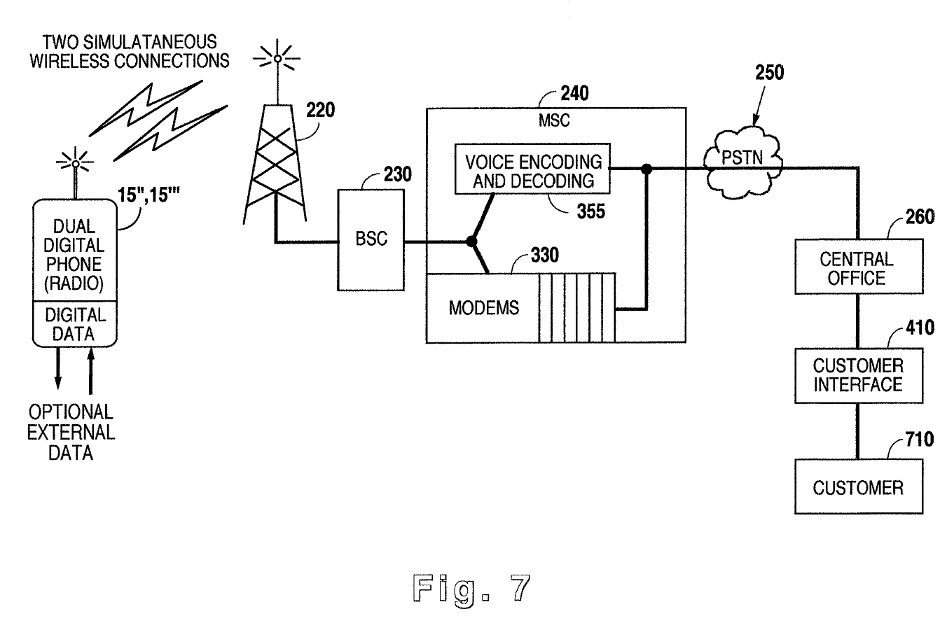

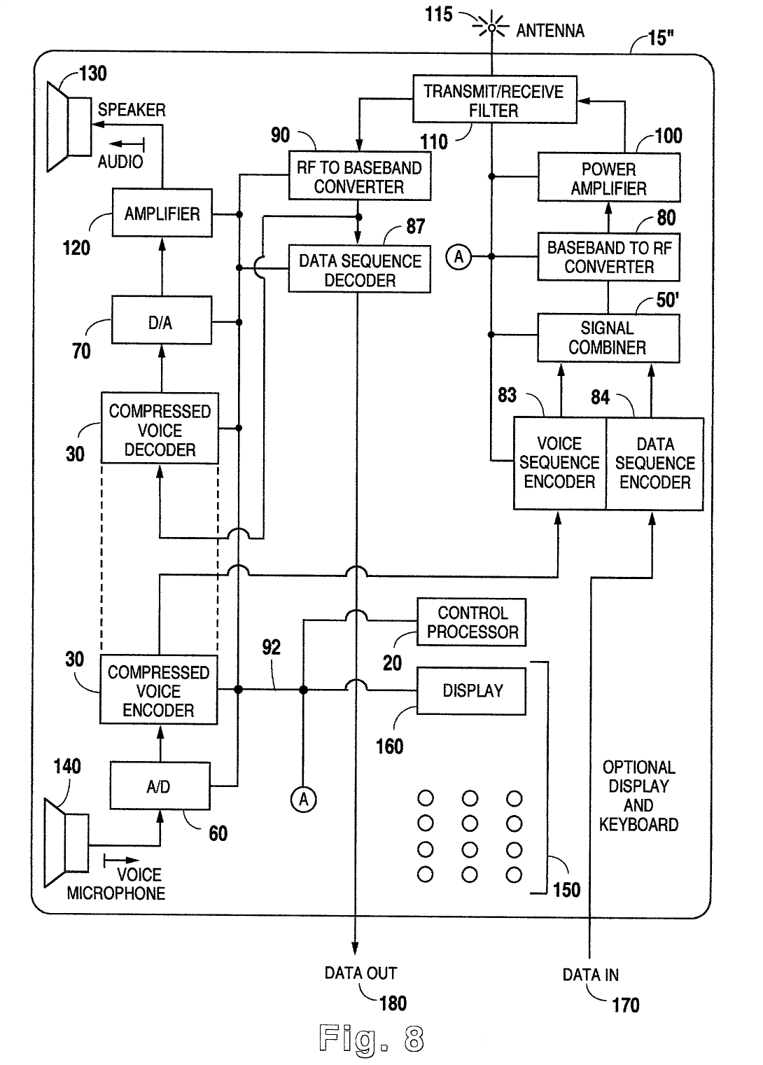

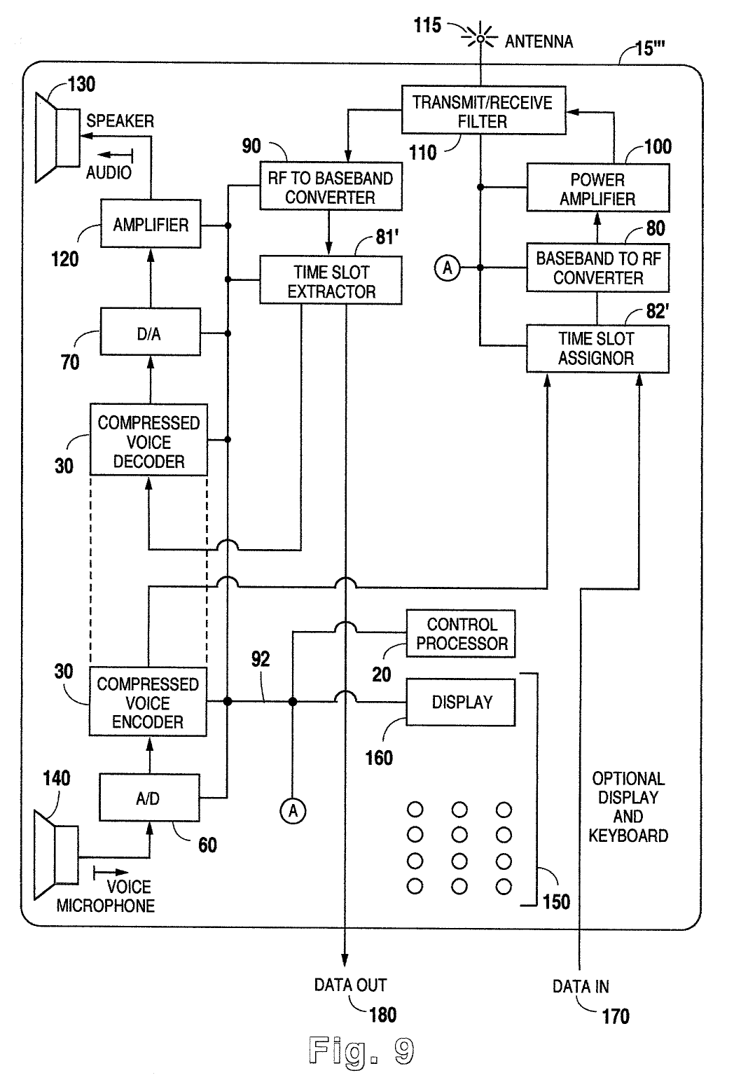

FIG. 7 illustrates the method and apparatus of the invention as used in a voice session and an independent digital data session in progress simultaneously. This connection differs from the previously described voice and digital data connection in that two independent communication sessions are occurring between the radio and the WSP. In this case, the packets to and from the dual-call wireless radio 15″ (which may be implemented as shown in FIGS. 8 and 9, described below) are identified as to type and intended destination. Voice data packets are identified as being vocoded and are decoded and sent on to their destination over the PSTN 250 or some other network. Other packets may be identified as non-voice (e.g., digital) data that can also be routed over the PSTN or some other network. If non-voice data is sent over the PSTN 250, then some method of encoding it to allow transmission over the PSTN 250 must be employed. Using a modem 330 at the WSP can accomplish this task. The two communication sessions can also be two voice or two digital data sessions. In fact, many such communication sessions can be in progress simultaneously. Only the limit of processing power in the mobile unit and/or the destination limits the number of such sessions that can operate simultaneously.

In applications where voice data and digital data from the wireless radio 15″ need to both arrive at the same remote destination 410, both sessions can be opened at the same time. Although not necessary, opening both of the communication sessions at the same time makes implementation easier. The wireless radio 15″ first communicates its desire to open up two sessions, for example, one a voice data session and the other a non-voice (e.g., digital) data session. The destinations are defined in a format consistent with their operation; i.e. the voice data session destination is a PSTN telephone number and the non-voice data connection specifies either a PSTN phone number (using the modem 330 at the WSP MSC 240) or some other destination code, such as an IP address over the Internet. The WSP treats the two sessions as separate and directs the information for each of them to independent destinations. In one application the voice and digital data must be delivered to the same location, such as an emergency call center 710. These centers 710 could have many stations each handling separate calls and each combining the voice data and digital data for simultaneous use. An example of such circumstances includes the activity of an emergency communication specialist at the destination talking to a person using a mobile unit 15″ while receiving data such as location, equipment status, medical diagnostic information, etc. which are related to the mobile unit 15″ and its operator. A problem encountered in this scenario is that a voice connection over tip and ring analog lines may not provide caller identification. Even with digital PBX systems the automatic number identification (ANI) is notoriously unreliable. Therefore, it may fall to the operator at the destination to identify the person to whom they are speaking (i.e., the mobile station operator, or customer). The destination operator would then have to look up an identity code of that customer and link that code to a data session that has probably already been established (with an unknown ultimate destination). The destination operator must find the customer=s name in some form of database, verify the identity selection with the wireless customer, and then select that identity as the one represented by the voice connection. To match up the voice with the data, the data connection must have already identified itself using that same identity code when the connection was originally established. A form of digital PBX might then steer the digital data connection to the same workstation as the voice call.

Using the invention, if a digital PBX connection is implemented at the response center and ANI is operational, the digital data connection can be steered to the proper workstation without human involvement. This is because the telephone number of the caller is provided via ANI from the telephone company through the PBX interface. The identification number can be compared to identification numbers for all of the digital data connections currently in progress for a match. If the calling number derived from the ANI matches the telephone number of a unit with a digital connection, then both the caller connection and the digital connection can be steered to the same workstation. If the modem 330 is used at the WSP for the voice connection, then the voice information can be carried as described above for a Circuit-Switched Voice and Data Connection (see FIG. 4), which has the advantage of using digital format all the way to the destination 410. ANI information can be embedded in the digital data frame along with the vocoded voice data. The caller=s identity is thus described and carried in the digital data frame so that automatic routing of the alternate digital data carried over a separate data connection can be accomplished.

If an alternate network is used as described above, a Voice and Data Connection over an Alternate Network (see FIG. 5), then the result would be the same. The voice portion would arrive at the destination 410 in digital form. Therefore, the identity of the caller can be established in a similar fashion and automatic combination of the voice and digital data can be accomplished.

FIG. 8 is a simplified drawing of an exemplary dual-call digital cellular 2-way radio 15″ configured for CDMA operation, and capable of implementing the method of the present invention. The telephone 15″ is especially useful for dual-call scenarios, such as that illustrated in FIG. 7. The dual-call CDMA radio 15″ is shown in the form of a simplified functional block diagram, as was done for the CDMA radio 15. The diagram arranged to show signal flow and does not necessarily represent actual hardware (although the phone 15″ may certainly be realized using hardware as illustrated). Those skilled in the art will know that many other implementations are possible. The control processor 20 moves data from one block to another across this internal bus 92. The CDMA code sequencers 83, 84, 87 are typically implemented in a dedicated digital signal processor (DSP). In the dual-call implementation, a circuit-switched voice call is placed and a circuit-switched data call is placed. Since it is reasonable to place one call before the other, when the second call is placed the radio 15″ should request the same channel as used by the first call.

As each call is established, the radio 15″ treats them as separate entities. The radio 15″ does not mix the calls in any way. The calls may be voice on one call and voice on the other, data on one call and data on the other, or voice on one call, and data on another. The voice path is the same as for any CDMA voice call. The circuit-switched data call is performed exactly as for the single-call radio 15. The main difference in the functionality of the dual-call radio 15″ is that the code-sequenced voice data and the code-sequenced alternate digital data are combined into a single signal and used to modulate the carrier. Therefore the output of the baseband to RF converter 80 contains both code sequences. The rest of the transmit path is the same for a single call radio.

The main difference with dual-call reception is that the output from the RF to baseband converter 90 is sent to both the voice sequence decoder and the alternate digital data sequence decoder (contained in the data sequence decoder 87, analagous to the voice sequence encoder 83 and the data sequence encoder 84). From these points on, the functionality is the same for a single call radio 15.

FIG. 9 is a simplified drawing of an exemplary alternative dual-call digital cellular 2-way radio 15′″ configured for TDMA operation, and capable of implementing the method of the present invention. As for the CDMA phone 15″, the dual-call TDMA radio 15′″ is shown as a simplified functional block diagram. It does not necessarily show all physical parts of the radio, but is used to provide an exemplary physical/logical model of an apparatus capable of executing the steps of the methods described herein. Thus, the blocks are arranged to show signal flow and do not necessarily represent actual hardware. The control processor 20 typically moves data from one block to another across an internal bus 92. As described in above, two calls, a circuit-switched voice call and a circuit-switched data call, are placed to begin the method of combining two calls onto a single channel.

Again, as each call is established, the radio 15′″ treats them as separate entities. The radio 15′″ does not mix the calls in any way. The voice path is the same as for any TDMA voice call. The circuit-switched data call is performed exactly as from a single-call radio 15. The main difference in the functionality of the radio 15′″ shown in FIG. 9 is that two time slots are assigned to this radio 15′″—one for the voice and one for the alternate digital data. The carrier is turned on for each of the two time slots and transmits its data during that time slot. The rest of the transmit path is the same as for a single call radio 15.

The main difference during dual-call reception is that the time slot extractor 81′ retrieves data from two time slots instead of just one. The voice data goes to the compressed voice decoder 30 and the alternate digital data is routed to the data output port 180. From these points on, the functionality is the same for a single call radio 15.

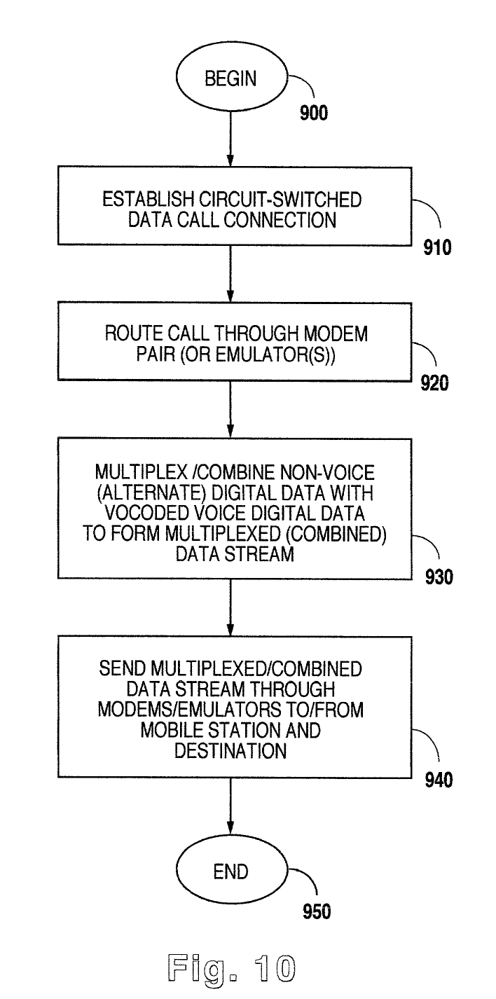

FIG. 10 is a flow chart diagram of the method of the invention. The method begins at step 900 and continues at step 910 with establishing a circuit-switched call connection between a calling party, such as one of the mobile units 15, 15′, 15″, or 15′″, and a destination, such as another mobile unit 15, 15′, 15″, or 15′″, or a destination unit 410, shown in FIG. 5. In some implementations, the mobile unit may not be allowed to complete the call unless the SO specifies circuit-switched data.

The method continues with 920, where the call is routed through a pair of modems 330, 340, or a pair of modem emulators 332, 342. The modems/emulators are connected in-line with the call connection path. The method then continues with multiplexing non-voice (alternate) digital data with vocoded digital voice data to form a multiplexed digital data stream in step 930.

The next step in the process involves sending the resulting data stream through the modems/emulators. Thus, step 940 includes sending the combined/multiplexed resulting digital data stream to/from the destination 15, 15′, 15″, 15′″, or the destination unit 410, and the mobile unit 15, 15′, 15″, 15′″. The method ends with step 950.

Many protocols for Simultaneous Voice and Data (SVD) frame transmission can be developed for use with the method and apparatus of the invention. An exemplary simple, proof-of-concept protocol follows below. Changes are discussed that can be made to improve efficiency and/or reduce delay.

The assumptions in this first exemplary protocol (see Tables I and II) and the others described hereinafter are: a maximum of one data packet can be interleaved between voice packets; and data packet delivery is synchronized so that a data packet, if one is ready, is delivered immediately after delivery of a voice packet (this ensures that voice packets will not be delayed by transmission of multiple data packets).

The first exemplary protocol uses separate voice and data packets as shown below.

TABLE I

| Voice | |
|---|---|
| Packet | Size |
| Fields | (Bytes) |
| Sync | 2 |
| Type | 1 |
| Sequence | 1 |
| Size | 1 |
| Coded Voice | 17 |
| Coded Voice | 17 |
| Coded Voice | 17 |
| Coded Voice | 17 |
| CRC | 2 |
| TOTAL | 75 |

TABLE II

| Data | |
|---|---|
| Packet | Size |
| Fields | (Bytes) |
| Sync | 2 |
| Type | 1 |
| Sequence | 1 |
| Size | 1 |
| Data | 1-48 |
| TOTAL | 22 |

This protocol gives a media efficiency of 90.7% for voice, as high as 87.3% for data, a reception delay of 80 ms, and a data bandwidth of 4800 bps using an IS-95 CDMA channel and a 14.4 kbits/second data rate. The following descriptions of performance refer to this same assumed transmission standard and data rate.

The second exemplary protocol is designed as a minimal delay protocol, wherein only one coded voice field is included in each packet (see Tables III and IV). Since efficiency is important, a one byte sync field is used, and the size field is removed for voice packets, since they are always a fixed size.

TABLE III

| Voice | |
|---|---|
| Packet | Size |
| Fields | (Bytes) |
| Sync | 1 |
| Type | 1 |
| Sequence | 1 |
| Coded Voice | 17 |
| CRC | 2 |
| TOTAL | 225 |

TABLE IV

| Data | |
|---|---|
| Packet | Size |
| Fields | (Bytes) |
| Sync | 1 |
| Type | 1 |
| Size | 1 |
| Data | 1-5 |
| CRC | 2 |
| Total | 6-10 |

This gives a media efficiency of 77% for voice, as high as 50% for data, a reception delay of 20 ms, and a data bandwidth of 2100 bits/second.

The third exemplary protocol is a combined minimal protocol which results from combining voice and data in a single packet, eliminating one of the header fields (see Table V). This third exemplary protocol gives a media efficiency as high as 81%, a delay of 20 ms, and a data bandwidth of 3600 bps.

TABLE V

| Voice | |
|---|---|
| Packet | Size |
| Fields | (Bytes) |
| Sync | 1 |
| Type | 1 |
| Sequence | 1 |
| Data Size | 1 |
| Coded | 17 |
| Voice | |
| Data | 0-9 |
| CRC | 2 |
| Total | 32 |

Although the invention has been described with reference to specific embodiments, this description is not meant to be construed in a limited sense. The various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents.

What is claimed is:

1. A method of combining voice and data for transmission during a single digital wireless telephone call, comprising the steps of:
establishing a circuit-switched data call connection from a mobile phone to a destination;
routing the call through a pair of modems connected in-line with the call connection path;
multiplexing non-voice digital data with vocoded voice digital data to form a multiplexed digital data stream; and
sending the multiplexed digital data stream from the mobile phone to the destination through the pair of modems.

2. A method of combining voice and data for transmission during a single digital wireless telephone call, comprising the steps of:
establishing a circuit-switched data call connection from a destination to a mobile phone, wherein the mobile phone is allowed to complete the call connection only if the call service option specifies circuit-switched data;
routing the call through a pair of modems connected in-line with the call connection path;
multiplexing non-voice digital data with vocoded voice digital data to form a multiplexed digital data stream; and
sending the multiplexed digital data stream from the destination to the mobile phone through the pair of modems.

3. A method of establishing a plurality of simultaneous connections between a digital cellular radio and a wireless system provider, comprising the steps of:
establishing a voice connection between the digital cellular radio and a wireless system provider; and
establishing a digital data connection between the digital cellular radio and a wireless system provider wherein the voice connection and the digital data connection are being active at the same time and treated independently by the wireless system providers.

4. The method of claim 3 wherein the voice connection and the digital data connection are made to the same destination.

5. The method of claim 4 wherein the destination is an operator workstation.

6. The method of claim 5 where the digital data connection carries information about the voice connection.

7. A telephone for combining voice and data into a transmitted digitized data stream to be transmitted by way of a single digital wireless telephone call and for receiving a received digitized data stream including received voice data and received non-voice data, the telephone having a voice input, a sound output, a data input, a non-voice data output, and an antenna, the telephone comprising:
a vocoder having an encoder including a digitized voice input and an encoded voice data output, and a decoder including a received voice data input and decoded voice data output;
a microphone operatively connected to an analog-to-digital converter which provides a digitized voice data stream to the digitized voice input in response to the voice input;
a speaker operatively connected to a digital-to-analog converter which receives a digital data stream from the vocoder decoded voice output to provide the sound output;
a multiplexor having a multiplexed data output, an encoded voice input, and a data input, the multiplexor operatively connected to receive the encoded voice output at the encoded voice input and the data at the data input so as to provide a transmitted digitized data stream; and
a demultiplexor having a converted data input, a voice data output, and a non-voice data output, the converted data input operatively connected to receive the received digitized data stream, the voice data output operatively connected to provide received voice data to the decoder received voice data input, and the non-voice data output operating to provide the received non-voice data to the non-voice data output.

8. The telephone of claim 7, further comprising:
a destination in electronic communication with the telephone.

9. A system for managing a combined data stream, comprising:
a telephone for combining voice and data into a transmitted digitized data stream to be transmitted by way of a single digital wireless telephone call and for receiving a received digitized data stream including received voice data and received non-voice data, the telephone having a voice or sound input, a sound output, a data input, a non-voice data output, and an antenna, the telephone comprising:
a vocoder having an encoder including a digitized voice input and an encoded voice data output, and a decoder including a received voice data input and decoded voice data output;
a microphone operatively connected to an analog-to-digital converter which provides a digitized voice data stream to the digitized voice input in response to the voice or sound input;
a speaker operatively connected to a digital-to-analog converter which receives a digital data stream from the vocoder decoded voice output to provide the sound output;
a multiplexor having a multiplexed data output, an encoded voice input, and a data input, the multiplexor operatively connected to receive the encoded voice output at the encoded voice input and the data at the data input so as to provide a transmitted digitized data stream; and
a demultiplexor having a converted data input, a voice data output, and a non-voice data output, the converted data input operatively connected to receive the received digitized data stream, the voice data output operatively connected to provide received voice data to the decoder received voice data input, and the non-voice data output operating to provide the received non-voice data to the non-voice data output; and
a mobile switching center including a first modem, the mobile switching center operatively coupled to the telephone so as to receive a representation of the amplified output data stream from the telephone and to send the representation of the amplified output data stream to the first modem, and to receive a representation of the received digital data stream from the first modem and to send the representation of the received digital data stream to the telephone;
a central office connected to the first modem; and
a destination including a second modem connected to the central office.
